(19) United States
(12) Patent Application Publication
(10) Pub. No.: US 2014/0318631 A1
(43) Pub. Date: Oct. 30, 2014

(54) METHODS AND SYSTEMS FOR CONVERTING FOOD WASTE OIL INTO BIODIESEL FUEL

(71) Applicant: Revolution Fuels, Inc., Minneapolis, MN (US)

(72) Inventors: James M. Rethore, Forest, VA (US); Julie E. Wheeler, Minneapolis, MN (US); Steven G. Polski, Cottage Grove, MN (US)

(73) Assignee: Revolution Fuels, Inc., Minneapolis, MN (US)

(21) Appl. No.: 14/359,475

(22) PCT Filed: Nov. 27, 2012
(86) PCT No.: PCT/US2012/066680

§ 371 Date: May 20, 2014

Related U.S. Application Data
(60) Provisional application No. 61/563,922, filed on Nov. 28, 2011.

(51) Int. Cl. C10L 1/02; G06Q 30/02; G06Q 50/06; G06Q 30/06

(52) U.S. Cl. CPC C10L 1/02; G06Q 30/0601; G06Q 30/0241; G06Q 50/06
USPC 137/1; 44/307

(57) ABSTRACT

This invention provides the market with low-cost retrieval of valuable used cooking oil to customer distribution centers, where a mobile production unit visits to create biodiesel fuel, which can be immediately used by customers to fuel their fleet. In some variations, a method comprises identifying a network of customer distribution centers, collecting used cooking oil transported from users to customer distribution centers, providing a mobile reactor to convert used cooking oil into biodiesel fuel under effective reaction conditions, producing biodiesel fuel on-site at the customer distribution centers, and introducing the biodiesel fuel, directly or via a fuel blend, into fleet vehicles. Related systems and apparatus are also disclosed. This invention provides a clean source of energy from waste, a lower-cost alternatives to petroleum-derived diesel fuel, and improved environmental footprints including lower fuel use and lower total carbon emissions.

### PRIORITY DATA

This international patent application claims priority to U.S. Patent App. No. 61/563,922, filed Nov. 28, 2011 for METHODS AND SYSTEMS FOR CONVERTING FOOD WASTE OIL INTO BIODIESEL FUEL, which is hereby incorporated by reference herein.

### FIELD OF THE INVENTION

The present invention generally relates to methods and systems for the conversion of used cooking oil into biodiesel fuel.

### BACKGROUND OF THE INVENTION

Biodiesel fuel is a diesel fuel consisting of long-chain alkyl esters, derived from vegetable oil or animal fat. Biodiesel fuel can be made by chemically reacting lipids with an alcohol, typically methanol or ethanol. Biodiesel fuel can be used in standard diesel engines, either alone or blended with petroleum-derived diesel fuel. Biodiesel fuel can also be used as a low-carbon alternative to heating oil.

Biodiesel fuel is a renewable fuel with lower emissions than those associated with petroleum-derived diesel fuel. Since the passage of the Energy Policy Act of 2005, biodiesel fuel use has been increasing in the United States. Biodiesel fuel has virtually no sulfur content, and it is often used as an additive to Ultra-Low Sulfur Diesel fuel. Biodiesel fuel has much higher cetane ratings than lower-sulfur diesel fuels. Biodiesel fuel addition reduces fuel system wear, and can increase the life of fuel-injection equipment that relies on the fuel for its lubrication.

There is significant global interest in producing fuels and chemicals from renewable resources. Concurrently, there is a driver to utilize non-food feedstocks and other waste materials that do not cause supply concerns within food business systems. In the context of biodiesel fuels, there is an interest in using waste grease, rather than fresh vegetable oil, to make biodiesel fuel. This approach can essentially double the productive value of vegetable oil, and not use a food (fresh oil) as a fuel.

In the cooking-oil market today, one problem that exists is that distribution centers deliver fresh oil to customers (e.g., restaurants) and then return with empty containers. Later, after the oil has been used, collectors—on separate trucks and routes—travel to the distribution centers with empty containers to pick up the used oil. There is a desire to improve the overall efficiency of this process, including eliminating the separate collection routes, for example. By eliminating miles, labor, and equipment from customers supply chains, much wasted effort and cost can be removed from the system.

The cooking-oil industry, and the food industry in general, desires clean sources of energy; lower-cost alternatives to petroleum-derived diesel fuel; the ability to convert waste into value; and improved environmental life cycles in the supply chain, including lower fuel use and lower total carbon emissions. What is needed is a better method and system for converting used cooking oil into biodiesel fuel.

### SUMMARY OF THE INVENTION

In some variations, this invention provides a method of providing a service to cooking oil users, distributers, or other market participants, the method comprising:

(a) identifying a network comprising a plurality of customer distribution centers, wherein each of the customer distribution centers is associated with a plurality of users of cooking oil;

(b) at a first customer distribution center, collecting used cooking oil transported from at least some of the users associated with the first customer distribution center, and introducing the used cooking oil to a first storage unit;

(c) providing a mobile reactor configured to convert used cooking oil into biodiesel fuel under effective reaction conditions;

(d) transporting the mobile reactor to the first customer distribution center;

(e) feeding at least some of the used cooking oil contained in the first storage unit to the mobile reactor;

(f) feeding an alcohol and a catalyst to the mobile reactor, under effective reaction conditions and in the presence of the used cooking oil, to produce biodiesel fuel on-site at the first customer distribution center; and

(g) introducing at least some of the biodiesel fuel, directly or via a fuel blend, into one or more fleet vehicles associated with the first customer distribution center.

In some embodiments, the method further comprises:

(h) at additional customer distribution centers, collecting used cooking oil transported from at least some of the users associated with each of the additional customer distribution centers, and introducing the used cooking oil to individual storage units located at each of the additional customer distribution centers;

(i) transporting the mobile reactor to each of the additional customer distribution centers;

(j) at each of the additional customer distribution centers, feeding at least some of the used cooking oil contained in each of the individual storage units to the mobile reactor; and

(k) at each of the additional customer distribution centers, feeding methanol and a catalyst to the mobile reactor, under effective reaction conditions and in the presence of the used cooking oil, to produce biodiesel fuel on-site at each of the additional customer distribution centers.

The present invention is not limited to any particular type of oil. In some variations, the cooking oil is derived from a food source selected from the group consisting of soybeans, corn, canola, rice, olive, coconut, cottonseed, palm, peanut, rapeseed, safflower, sesame, sunflower, pumpkin, grape, animal fat, energy crops, and combinations thereof. In various embodiments, at least some of the used cooking oil is generated by restaurants, grocers, or intermediaries who handle or distribute cooking oil to end users.

In some embodiments, the method further comprises, at each of the additional customer distribution centers, introducing at least some of the biodiesel fuel produced in step (k), directly or via a fuel blend, into one or more fleet vehicles associated with the additional customer distribution centers.

A vehicle may be provided to transport fresh cooking oil to each of the plurality of users of cooking oil. The vehicle may further be employed to transport the used cooking oil to the first customer distribution center.

The network may include, for example, at least 10, 20, 30, 40, 50, 60, 70, 80, 90, 100 or more customer distribution centers.

Multiple mobile reactors may be provided, each reactor configured to convert used cooking oil into biodiesel fuel under effective transesterification conditions. Multiple mobile reactors may be provided for individual distribution centers, if necessary.

In some embodiments, substantially all of the biodiesel fuel is introduced, directly or via a fuel blend, into one or more fleet vehicles associated with the first customer distribution center. The biodiesel fuel may be utilized to power a vehicle to transport fresh cooking oil to a user of cooking oil. The biodiesel fuel may be utilized to power a vehicle to transport the used cooking oil to the first customer distribution center. The biodiesel fuel may be utilized to power a supplier vehicle to deliver fresh cooking oil to the first customer distribution center, and/or for a return trip for the supplier vehicle back to a supplier location. In certain embodiments, a portion of the biodiesel fuel is separately marketed or sold.

In some embodiments of the invention, the method further comprises transporting the mobile reactor directly to at least one of the plurality of users of cooking oil, in addition to transporting the mobile reactor to a customer distribution center. In some embodiments, the mobile reactor may also be transported to a supplier or refiner of fresh cooking oil, to convert waste oil or off-spec cooking oil into biodiesel fuel.

In some embodiments, used cooking oil generated by a user associated with the first customer distribution center is evacuated from a cooker into a portable container, followed by pumping the used cooking oil to interior tank storage at a storage site of the user. In some embodiments, used cooking oil generated by a user is directly evacuated from a cooker into interior or exterior tank storage at a storage site of the user. In these or other embodiments, used cooking oil generated by a user is evacuated from a cooker into a portable container, followed by pumping the used cooking oil to exterior tank storage at a storage site of the user.

The used cooking oil in the tank storage may be collected by a vacuum system mounted on the trailer of a user delivery truck, and conveyed into an on-board storage tank disposed on the user delivery truck, for example. Alternatively, or additionally, the used cooking oil in the tank storage may be collected by a vacuum system mounted on the cab of a user delivery truck, and conveyed into an on-board storage tank disposed on the user delivery truck.

In some embodiments, a vehicle is provided to transport fresh cooking oil to at least one of the plurality of users of cooking oil; the vehicle is further employed to transport the used cooking oil to the first customer distribution center; and the used cooking oil in the tank storage is collected by a vacuum system mounted directly on the vehicle and conveyed into an on-board storage tank disposed on the vehicle.

In certain embodiments, used cooking oil generated by a user associated with the first customer distribution center is introduced into a portable, reusable container which is transported to the first customer distribution center. The used cooking oil from the portable, reusable container may be conveyed into the first storage unit at the first customer distribution center. Or, the portable, reusable container may itself be the first storage unit, or a sub-unit thereof, at the first customer distribution center.

In some embodiments, step (g) comprises pumping the biodiesel fuel into an on-site biodiesel storage tank, followed by introducing or blending the biodiesel fuel into a customer fueling system configured to provide fuel for the fleet vehicles associated with the first customer distribution center. The on-site biodiesel storage tank may be directly piped to the customer fueling system. The customer fueling system may be capable of accepting the biodiesel fuel conveyed directly from portable tanks or containers, in some embodiments.

In preferred embodiments of the invention, substantially no wastewater is directly discharged in connection with production of the biodiesel fuel. The mobile reactor may be operated to be self-sufficient for energy demand, and in some embodiments the mobile reactor does not require on-site utilities. Generally, this invention provides a green process for producing biodiesel fuel. In some embodiments, the method further comprises a step of managing renewable identification numbers and/or credits associated with the biodiesel fuel.

This invention also provides, in some variations, a method of converting used cooking oil into biodiesel fuel, the method comprising:

(a) introducing, or causing to be introduced, used cooking oil into a used oil storage unit at a customer site;

(b) transporting a mobile reactor to the customer site using a reactor vehicle, wherein the mobile reactor is configured to continuously convert used cooking oil into biodiesel fuel under effective reaction conditions;

(c) feeding at least some of the used cooking oil contained in the used oil storage unit to the mobile reactor; and

(d) feeding an alcohol and a transesterification catalyst to the mobile reactor, under the effective reaction conditions and in the presence of the used cooking oil, to continuously or semi-continuously produce biodiesel fuel on-site at the customer site.

In some embodiments, the mobile reactor is capable of processing at least about 500 gallons of the used cooking oil per hour, such as at least about 1000 gallons of the used cooking oil per hour. The mobile reactor is capable of operating to continuously convert a source of used cooking oil at a customer site to biodiesel fuel.

The used cooking oil may be derived from a food source selected from the group consisting of soybeans, corn, canola, rice, olive, coconut, cottonseed, palm, peanut, rapeseed, safflower, sesame, sunflower, pumpkin, grape, animal fat, energy crops, and combinations thereof Any type of animal fat may be used, including rendered fat, tallow, lard, etc.

In some embodiments, the alcohol comprises methanol, but higher alcohols may be used for the transesterification, including C₂-C₆ alcohols. A mixture of methanol and ethanol may be utilized, for example. The alcohol and the transesterification catalyst may be co-fed to the mobile reactor, at the same or different locations.

The transesterification catalyst may be a strong alkali catalyst. In some embodiments, the transesterification catalyst is an enzymatic transesterification catalyst. An esterification catalyst may also be introduced into the mobile reactor. The esterification catalyst may be an enzymatic esterification catalyst.

When the alcohol is (or includes) methanol, a glycerin product is co-produced from the transesterification. The glycerin may be separated and stored, sold, or used for various purposes. For example, the glycerin may be reformed to syngas, or directly oxidized, to generate power. In some embodiments, the glycerin (alone or in combination with biodiesel fuel) may be reformed or oxidized to generate combined heat and power. The power, or combined heat and power, may be utilized by the reactor vehicle, if desired.

The biodiesel fuel produced may be introduced, directly or via a fuel blend, into one or more fleet vehicles located at, or otherwise associated with, the customer site. A customer site may consist of a refiner of cooking oil, a supplier of cooking oil, a user of cooking oil, or a distribution center associated with a plurality of users of cooking oil.

Variations of the present invention relate to systems and apparatus, including systems and apparatus configured for carrying out any of the disclosed methods.

In some variations, the invention provides a system for providing a service to cooking oil users, distributers, or other market participants, the system comprising a computer server configured to exchange data with the Internet, the server computer having a processor, an area of main memory for executing program code under the direction of the processor, a storage device for storing data and program code and a bus connecting the processor, main memory, and the storage device; the code being stored in the storage device and executing in the main memory under the direction of the processor, to perform the steps of:

(a) identifying a network comprising a plurality of customer distribution centers, wherein each of the customer distribution centers is associated with a plurality of users of cooking oil;

(b) at a first customer distribution center, collecting used cooking oil transported from at least some of the users associated with the first customer distribution center, and introducing the used cooking oil to a first storage unit;

(c) providing a mobile reactor configured to convert used cooking oil into biodiesel fuel under effective reaction conditions;

(d) transporting the mobile reactor to the first customer distribution center;

(e) feeding at least some of the used cooking oil contained in the first storage unit to the mobile reactor;

(f) co-feeding methanol and a catalyst to the mobile reactor, under the effective reaction conditions, to produce biodiesel fuel on-site at the first customer distribution center; and

(g) introducing at least some of the biodiesel fuel, directly or via a fuel blend, into one or more fleet vehicles associated with the first customer distribution center.

In some embodiments, the code under the direction of the processor is programmed to perform the additional steps of:

(h) at additional customer distribution centers, collecting used cooking oil transported from at least some of the users associated with each of the additional customer distribution centers, and introducing the used cooking oil to individual storage units located at each of the additional customer distribution centers;

(i) transporting the mobile reactor to each of the additional customer distribution centers;

(j) at each of the additional customer distribution centers, feeding at least some of the used cooking oil contained in each of the individual storage units to the mobile reactor; and

(k) at each of the additional customer distribution centers, feeding methanol and a catalyst to the mobile reactor, under effective reaction conditions and in the presence of the used cooking oil, to produce biodiesel fuel on-site at each of the additional customer distribution centers.

A system for providing a service to cooking oil users, distributers, or other market participants, is also provided herein, comprising:

(a) a computer server connected to the Internet;

(b) executable program code configured to create or maintain a database of customer distribution centers, wherein each of the customer distribution centers is associated with a plurality of users of cooking oil, and wherein the database is connected to the computer server;

(c) a user interface programmed to allow selection of a first customer distribution center from the database;

(d) a first storage unit, at the first customer distribution center, for collecting used cooking oil transported from at least some of the users associated with the first customer distribution center;

(e) a mobile reactor configured to convert used cooking oil into biodiesel fuel under effective transesterification conditions at the first customer distribution center;

(f) a first pump or other means for feeding at least some of the used cooking oil contained in the first storage unit to the mobile reactor;

(g) a second pump or other means for feeding methanol and a catalyst to the mobile reactor, under effective reaction conditions and in the presence of the used cooking oil, to produce biodiesel fuel on-site at the first customer distribution center; and

(h) a third pump or other means for introducing at least some of the biodiesel fuel, directly or via a fuel blend, into one or more fleet vehicles associated with the first customer distribution center.

The user interface may be programmed to allow selection of additional customer distribution centers included in the database; the system further comprising:

(i) individual storage units located at each of the additional customer distribution centers;

(j) first additional pumps or other means for feeding at least some of the used cooking oil contained in the individual storage units to the mobile reactor;

(k) second additional pumps or other means for feeding methanol and a catalyst to the mobile reactor, under effective reaction conditions and in the presence of the used cooking oil, to produce biodiesel fuel on-site at each of the additional customer distribution centers; and

(l) third additional pumps or other means for introducing at least some of the biodiesel fuel, directly or via a fuel blend, into one or more fleet vehicles associated with each of the additional customer distribution centers.

In some embodiments, the system further includes an optimization routine for route planning or for dynamic route adjustments. In some embodiments, the mobile reactor can be operated, at least in part, remotely via connection between the computer server and an on-board computer attached to the mobile reactor.

In certain embodiments, the system further includes program code for managing the generation and/or disposition of renewable identification numbers associated with the biodiesel fuel.

The system of the invention may be adapted for a mobile-computing application on any known platform and media, if desired.

The invention provides a biodiesel fuel composition produced by a process as disclosed. A diesel fuel may be produced, including this biodiesel fuel composition, and used in any known diesel fuel application.

### BRIEF DESCRIPTION OF THE FIGURES

FIG. 1 illustrates the overall material flow in some method and system variations of the present invention.

FIG. 2 depicts a network of distribution centers, each associated with multiple users, involved in conversion of used cooking oil into biodiesel fuel, in some variations of the invention.

FIG. 3 shows an exemplary process flow with multiple steps including collection of used cooking oil, storage at a distribution center, processing using a mobile reactor to produce biodiesel fuel, and on-site blending by a customer.

FIG. 4 reveals an exemplary truck retrofitted with a vacuum system mounted on the trailer for collecting used cooking oil, in some embodiments.

FIG. 5 is a block-flow diagram associated with a mobile reactor arrangement, according to certain embodiments of this invention.

### DETAILED DESCRIPTION OF EMBODIMENTS OF THE INVENTION

Certain embodiments of the present invention will now be further described in more detail, in a manner that enables the claimed invention so that a person of ordinary skill in this art can make and use the present invention. These and other embodiments, features, and advantages of the present invention will become more apparent to those skilled in the art when taken with reference to the following detailed description of the invention in conjunction with the accompanying drawings.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. If a definition set forth in this section is contrary to or otherwise inconsistent with a definition set forth in patents, published patent applications, and other publications that are herein incorporated by reference, the definition set forth in this specification prevails over the definition that is incorporated herein by reference.

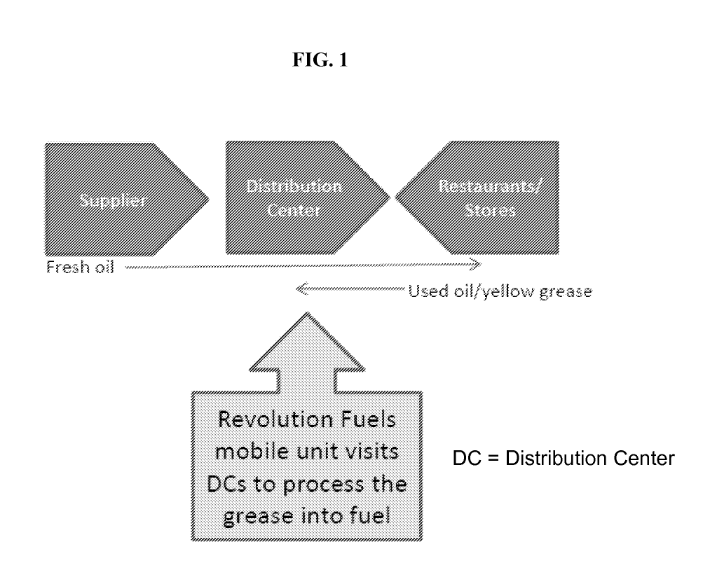

Variations of this invention are premised, at least in part, on the realization that biodiesel fuel may be produced from used cooking oil to fuel foodservice fleets. The invention assists customers in retrieving used cooking oil (from within their networks) back to their distribution centers, where a mobile reactor will visit and process the used cooking oil into biofuel on-site (FIG. 1). This detailed description illustrates by way of example, not by way of limitation, the principles of the invention.

Biodiesel fuel can be produced by transesterifying triglycerides with alcohols. Triglycerides are esters of glycerin (also known as glycerol, CH₂OHCHOHCH₂OH), and three fatty acids. Fatty acids are aliphatic compounds containing 4 to 24 carbon atoms and having a terminal carboxyl group. Triglycerides are found in a large variety of fats and oils, including natural oils as well as industrial and commercial waste oils.

As used herein, “used cooking oil” means any source of vegetable oil or animal fat that has been commercially used in some manner. Typically, used cooking oil has been employed for a period of time as frying oil to cook foods, but use as a frying oil is not necessary. Other sources of used cooking oils include waste oils derived from cooking oil production (refining), waste oils recovered during food processing and handling, and the like. The used cooking oil may be edible or inedible oil, with any number of impurities present. Used cooking oil may be generated by restaurants and grocers who control or own yellow grease, intermediaries who handle/distribute vegetable oil to end users, and others who accumulate oil, waste oil, fats, and greases.

“Biodiesel fuel” as intended herein is meant to be broadly construed to include liquid fuels for vehicles that travel over land (e.g., trucks), rail (e.g., trains), water (e.g., ships), and air (e.g., aircraft). Biodiesel fuel also can be suitable for stationary power applications, such as fuel oil or gas turbine fuel. For any of these applications, biodiesel fuel can be used alone or in blended form with petroleum-derived diesel fuel, or with another source of diesel fuel such as Fischer-Tropsch fuels from synthesis gas.

In some variations, this invention provides a method of providing a service to cooking oil users, distributers, or other market participants, the method comprising:

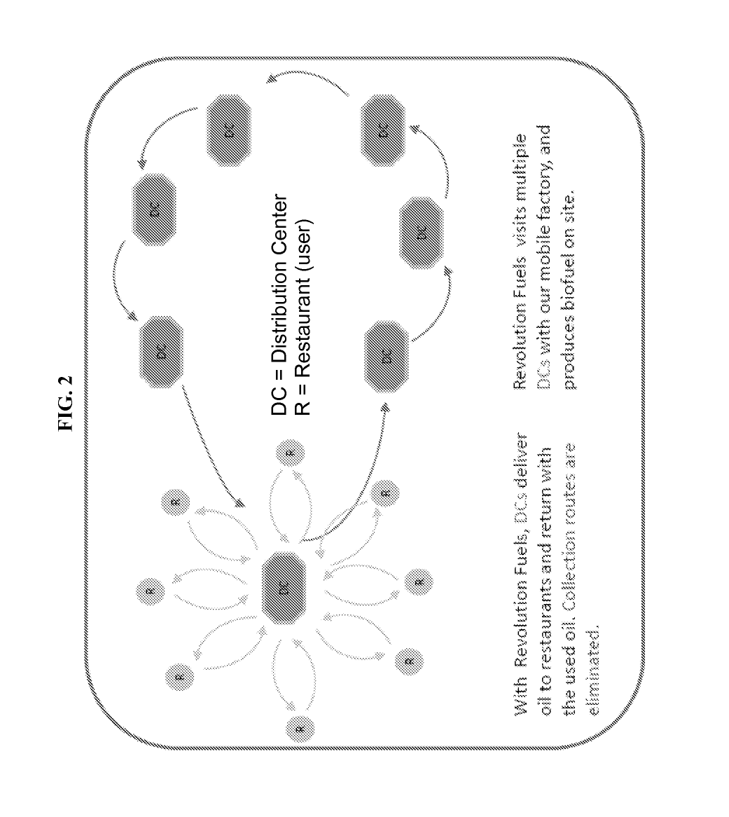

(a) identifying a network comprising a plurality of customer distribution centers, wherein each of the customer distribution centers is associated with a plurality of users of cooking oil (an exemplary network is shown in FIG. 2);

(b) at a first customer distribution center, collecting used cooking oil transported from at least some of the users associated with the first customer distribution center, and introducing the used cooking oil to a first storage unit;

(c) providing a mobile reactor configured to convert used cooking oil into biodiesel fuel under effective reaction conditions;

(d) transporting the mobile reactor to the first customer distribution center;

(e) feeding at least some of the used cooking oil contained in the first storage unit to the mobile reactor;

(f) feeding an alcohol and a catalyst to the mobile reactor, under effective reaction conditions and in the presence of the used cooking oil, to produce biodiesel fuel on-site at the first customer distribution center; and

(g) introducing at least some of the biodiesel fuel, directly or via a fuel blend, into one or more fleet vehicles associated with the first customer distribution center.

In some embodiments, the method further comprises:

(h) at one or more additional customer distribution centers, collecting used cooking oil transported from at least some of the users associated with each of the additional customer distribution centers, and introducing the used cooking oil to individual storage units located at each of the additional customer distribution centers;

(i) transporting the mobile reactor to each of the additional customer distribution centers;

(j) at each of the additional customer distribution centers, feeding at least some of the used cooking oil contained in each of the individual storage units to the mobile reactor; and

(k) at each of the additional customer distribution centers, feeding methanol and a catalyst to the mobile reactor, under effective reaction conditions and in the presence of the used cooking oil, to produce biodiesel fuel on-site at each of the additional customer distribution centers.

The present invention is not limited to any particular type of oil. In some variations, the cooking oil is derived from a food source selected from the group consisting of soybeans, corn, canola, rice, olive, coconut, cottonseed, palm, peanut, rapeseed, safflower, sesame, sunflower, pumpkin, grape, animal fat, and combinations thereof. Any type of animal fat may be used, including rendered fat, tallow, lard, etc.

In some embodiments, the source of oil is one or more energy crops. An energy crop is a low-cost plant grown to produce at least energy in some form. Energy crops are not necessarily precluded from uses in food, and generally speaking, edible cooking oil may be extracted from an energy crop. For example, an energy crop may provide fermentable sugars for producing ethanol, while at the same time, provide extractable oil which may be converted into biodiesel fuel, either directly or following use as cooking oil.

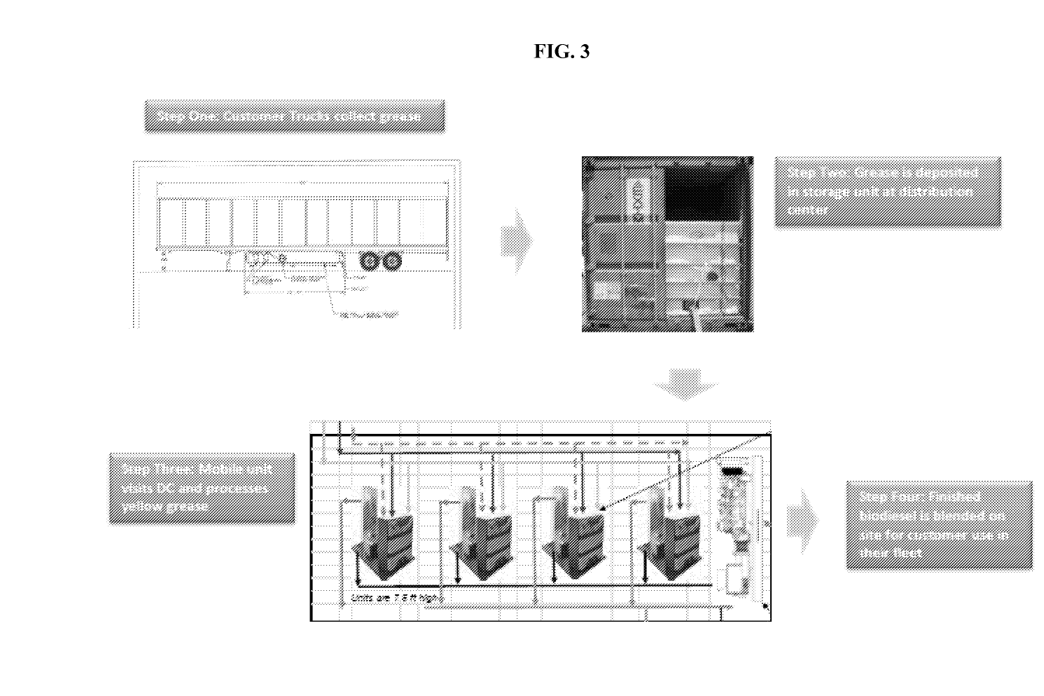

In various embodiments, the used cooking oil is generated by restaurants, grocers, or intermediaries who handle or distribute cooking oil to end users. FIG. 3 illustrates an exemplary overall process flow for some variations. Four steps are shown in FIG. 3, and these steps will be further described below.

In some embodiments, the method further comprises, at each of the additional customer distribution centers, introducing at least some of the biodiesel fuel produced in step (k), directly or via a fuel blend, into one or more fleet vehicles associated with additional customer distribution centers.

Each distribution center is associated with one or more users of cooking oil, such as depicted in FIG. 2. Typically, most or all of the distribution centers within the network are associated with multiple users, such as two, three, four, five, six, seven, eight, nine, or more individual users (e.g., restaurants). The network may include, for example, at least two, three, four, five, 10, 20, 30, 40, 50, 60, 70, 80, 90, 100 or more customer distribution centers.

Multiple mobile reactors may be provided, each reactor configured to convert used cooking oil into biodiesel fuel under effective transesterification conditions. Multiple mobile reactors may be provided for individual distribution centers, if necessary, such as for capacity reasons. On the other hand, single mobile reactors may be suitable for traveling to multiple distribution centers. The methods of the invention may employ one, two, three, four, five, or more mobile reactors.

In some embodiments, substantially all of the biodiesel fuel is introduced, directly or via a fuel blend, into one or more fleet vehicles associated with the first customer distribution center. The biodiesel fuel may be utilized to power a vehicle to transport fresh cooking oil to a user of cooking oil. The biodiesel fuel may be utilized to power a vehicle to transport the used cooking oil to the first customer distribution center. The biodiesel fuel may be utilized to power a supplier vehicle to deliver fresh cooking oil to the first customer distribution center, and/or for a return trip for the supplier vehicle back to a supplier location. If desired, a portion of the biodiesel fuel is separately marketed or sold.

In some embodiments of the invention, the method further comprises transporting the mobile reactor directly to at least one of the plurality of users of cooking oil, in addition to transporting the mobile reactor to a customer distribution center. In some embodiments, the mobile reactor may also be transported to a supplier or refiner of fresh cooking oil, to convert waste oil or off-spec cooking oil into biodiesel fuel.

A variety of receptacles may be provided to users of cooking oil to evacuate their used frying or cooking oil from their fryers or cookers. Options include portable containers (e.g., constructed from steel) pumped into interior or exterior tank storage, or direct evacuation of a cooker/dryer to interior or exterior tank storage.

In some embodiments, used cooking oil generated by a user associated with the first customer distribution center is evacuated from a cooker into a portable container, followed by pumping the used cooking oil to interior tank storage at a storage site of the user. In some embodiments, used cooking oil generated by a user is directly evacuated from a cooker into interior or exterior tank storage at a storage site of the user. In these or other embodiments, used cooking oil generated by a user is evacuated from a cooker into a portable container, followed by pumping the used cooking oil to exterior tank storage at a storage site of the user.

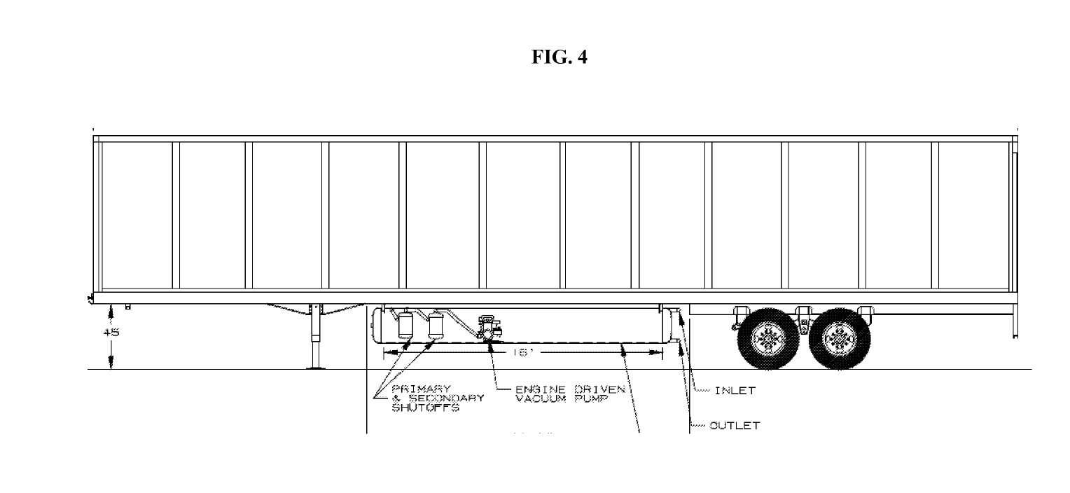

The used cooking oil in the tank storage may be collected by a vacuum system mounted on the trailer of a user delivery truck, and conveyed into an on-board storage tank disposed on the user delivery truck (see FIG. 4 for one example). Alternatively, or additionally, the used cooking oil in the tank storage may be collected by a vacuum system mounted on the cab of a user delivery truck, and conveyed into an on-board storage tank disposed on the user delivery truck.

The vacuum system employs a vacuum pump for conveying used cooking oil from tank storage to the on-board storage tank. Generally, vacuum pumps are combined with chambers and operational procedures into a wide variety of vacuum systems. The vacuum system may be engine-driven, in some embodiments.

The same vehicle that is used to transport fresh cooking oil to each of the users may further be employed to transport used cooking oil to the first customer distribution center and optionally to additional customer distribution centers.

In particular embodiments, the user delivery truck may be a customer's existing delivery truck, retrofitted with oil storage as described (e.g., FIG. 4). The used cooking oil will then reside in the on-board storage tank until its arrival back at the distribution center. At the distribution center, the used cooking oil will be pumped into an on-site storage tank where it will await processing into biodiesel fuel by the mobile reactor.

In some embodiments, a vehicle is provided to transport fresh cooking oil to at least one of the plurality of users of cooking oil; the vehicle is further employed to transport the used cooking oil to the first customer distribution center; and the used cooking oil in the tank storage is collected by a vacuum system mounted directly on the vehicle and conveyed into an on-board storage tank disposed on the vehicle.

In certain embodiments, used cooking oil generated by a user associated with the first customer distribution center is introduced into a portable, reusable container which is transported to the first customer distribution center. The used cooking oil from the portable, reusable container may be conveyed into the first storage unit at the first customer distribution center. Or, the portable, reusable container may itself be the first storage unit, or a sub-unit thereof, at the first customer distribution center.

In some embodiments, step (g), introducing biodiesel fuel into one or more fleet vehicles, comprises pumping the biodiesel fuel into an on-site biodiesel storage tank, followed by introducing or blending the biodiesel fuel into a customer fueling system configured to provide fuel for the fleet vehicles associated with the first customer distribution center. The on-site biodiesel storage tank may be directly piped to the customer fueling system. The customer fueling system may be capable of accepting the biodiesel fuel conveyed directly from portable tanks or containers, in some embodiments.

In preferred embodiments of the invention, substantially no wastewater is directly discharged in connection with production of the biodiesel fuel. The mobile reactor may be operated to be self-sufficient for energy demand, and in some embodiments the mobile reactor does not require on-site utilities, or has a very low utility demand.

In some embodiments of this invention, the method further comprises a step of managing renewable identification numbers (RINs), tax credits, and/or carbon credits associated with the biodiesel fuel. Such credits will vary in time, as a function of government policies and initiatives; the present invention can utilize, but is not limited by, any particular type of credit that may be available now or in the future.

A RIN is a 38-character numeric code that is generated by the producer or importer of renewable fuel representing gallons of renewable fuel produced/imported and assigned to batches of renewable fuel that are transferred (change of ownership) to others. RINs form a currency for the Renewable Fuel Standard for credits, trading, and use by obligated parties to demonstrate compliance, as well as track the volumes of renewable fuels.

Credits may be associated with blending biodiesel fuel with diesel fuel to produce, for example, B20 comprising 20 vol % biodiesel fuel. The methods of the invention may include various management steps relating to the volumetric blender tax credit, such as providing a certificate to the blender that identifies the product as biodiesel fuel that it is properly registered as a fuel with the EPA and that it meets the requirements of ASTM D6751.

Also, some embodiments include managing the Alternative Fuel Refueling Infrastructure Tax Credit that was established as part of the Energy Policy Act of 2005. This program provides a tax credit for the installation of certain qualifying fueling infrastructure that dispense alternative fuel, including biodiesel blends B20 and higher.

This invention also provides, in some variations, a method of converting used cooking oil into biodiesel fuel, the method comprising:

(a) introducing, or causing to be introduced, used cooking oil into a used oil storage unit at a customer site;

(b) transporting a mobile reactor to the customer site using a reactor vehicle, wherein the mobile reactor is configured to continuously convert used cooking oil into biodiesel fuel under effective reaction conditions;

(c) feeding at least some of the used cooking oil contained in the used oil storage unit to the mobile reactor; and

(d) feeding an alcohol and a transesterification catalyst to the mobile reactor, under effective reaction conditions and in the presence of the used cooking oil, to continuously or semi-continuously produce biodiesel fuel on-site at the customer site.

The used cooking oil may be derived from a food source selected from the group consisting of soybeans, corn, canola, rice, olive, coconut, cottonseed, palm, peanut, rapeseed, safflower, sesame, sunflower, pumpkin, grape, animal fat, energy crops, and combinations thereof Any type of animal fat may be used, including rendered fat, tallow, lard, etc.

The mobile reactor may be any type of reactor suitable for carrying out transesterification. Preferably, the reactor is a closed reaction vessel, to prevent loss of alcohol to the atmosphere. The mobile reactor can be engineered and operated in a wide variety of ways. The reactor operation can be continuous, semi-continuous, or batch, but it is preferably continuous or at least semi-continuous. Operation that is continuous and at steady state is preferable. The flow pattern can be substantially plug flow, substantially well-mixed, or a flow pattern between these extremes. The flow direction can be vertical-upflow, vertical-downflow, or horizontal. Any “reactor” herein can in fact be a series or network of several reactors in various arrangements on the reactor vehicle, such as depicted in the inset for step three of FIG. 3.

In some embodiments, the alcohol comprises methanol, but higher alcohols may be used for the transesterification, including C₂-C₆ alcohols (any isomers). A mixture of methanol and ethanol may be utilized, for example. Larger alcohols can have increased miscibility with the oil or fat that contains the reactant species (triglycerides). Another potential benefit to using longer-chain alcohols is that a higher reaction temperature can be used, because the boiling temperatures for the alcohols increase with chain length. The ability to run the transesterification reaction at higher temperatures can have a significant impact on the speed and efficiency of the desired chemistry. Higher reaction temperatures achievable with the longer-chain alcohols, coupled with the improved miscibility of the alcohols with hydrophobic triglycerides, can also allow for (in some embodiments) lower ratios of alcohol/fatty acid, minimizing costs and the quantity of unreacted materials.

When the alcohol reactant is obtained from a renewable resource (e.g., cellulosic ethanol or butanol from sugar fermentation), an additional amount of RINs or tax credits may be generated in connection with the biodiesel fuel produced. Thus, C₂ or higher alcohol reactants may be desired since methanol cannot be produced from sugar fermentation. Cellulosic methanol may be produced from syngas obtained from biomass gasification, for example, and use of this type of methanol to produce the biodiesel fuel may contribute additional RINs or tax credits, as well.

“Effective reaction conditions” for the reactions to produce biodiesel fuel from used cooking oil, will now be described.

The transesterification may be catalyzed with one or more acids or bases. It is generally preferred to employ base-catalyzed transesterification, as is known in the art, due to lower temperatures (and therefore pressures) possible, higher yields, reduced side reactions, and less-expensive materials of construction. Base catalysts can be strong alkali catalysts, such as sodium methoxide (also known as sodium methylate, CH₃ONa), sodium hydroxide, or potassium hydroxide. Acid catalysts can be, for example, sulfuric acid, hydrochloric acid, and other acids.

In some embodiments, a separate esterification catalyst is introduced into the mobile reactor. Or, the transesterification catalyst may also have esterification functionality, i.e. catalyze esterification reactions of free fatty acids.

In some embodiments, the transesterification catalyst is a free or immobilized enzymatic transesterification catalyst. An additional enzymatic esterification catalyst, which also may be free or immobilized, may be employed. Contrary to alkaline catalysts, enzymes do not form soaps and can esterify both free fatty acids and triglycerides in one step without the need of a subsequent washing step. Enzymes are potentially useful compared to alkaline or acid catalysts, because they are more compatible with variations in the quality of the raw material and are reusable; can produce biodiesel fuel in fewer process steps using less energy and with drastically reduced amount of wastewater; and can yield a higher quality of glycerin.

When enzymes are employed, it is desirable to include lipase functionality, in conjunction with a C₂ or larger alcohol (as methanol tends to inactivate lipase enzymes). A wide range of lipases has been used for enzymatic transesterification and esterification. Lipases from bacteria and fungi are the most commonly used for transesterification. In general, the best enzymes are able to reach conversions above 90%, while reaction temperatures vary between about 80-130° F. Reaction times also vary greatly, from about 10-100 hours with shorter times possible when employing immobilized enzymes.

The alcohol and the transesterification catalyst (and the optional esterification catalyst, if present) may be co-fed to the mobile reactor, at the same or different locations.

The reaction temperature for the reaction is not regarded as critical, but it can be preferable to maintain the temperature above the boiling point of one or more alcohols present, to speed up the reaction. Exemplary temperatures include about 80-250° F., such as about 100° F. or about 175° F. Excess alcohol can be used to increase transesterification reaction rates or to maintain favorable reaction equilibrium.

The reaction time for the reaction conducted in the mobile reactor is not regarded as critical, as long as it is suitable for a desired conversion and process throughput. Exemplary reaction times include about 5 minutes to about 8 hours or more, such as about 10 minutes, 20 minutes, 30 minutes, 45 minutes, 1 hour, 2 hours, or 4 hours.

In some embodiments, the mobile reactor is capable of processing at least about 500 gallons of the used cooking oil per hour, such as at least about 100, 200, 300, 400, 500, 600, 700, 800, 900, 1000 gallons, or more of the used cooking oil per hour. The mobile reactor is preferably capable of operating to continuously convert a source of used cooking oil (such as the entire amount of stored used cooking oil) at a customer site into biodiesel fuel.

In some embodiments, the process is controlled or adjusted to attain certain biodiesel fuel properties. As is known, relevant biodiesel fuel properties can include flash point, cetane number, energy content, cloud point, gel point, pour point, glycerol content, water content, sediment content, ash content, sulfur content, nitrogen content, phosphorus content, pH, density, viscosity, lubricity, and so on.

Following reaction, it is desirable to carry out separation to recover a relatively pure biodiesel fuel product. Other streams may include water, glycerin, and any unreacted feed materials (oils and alcohols). A separation unit is preferably one or more distillation columns, but any other known means of separation can be used. Other separation techniques can include or use flash vessels, centrifuges, cyclones, membranes, filters, and so on. Separation can be principally based, for example, on distillation, absorption, adsorption, or diffusion, and can utilize differences in vapor pressure, activity, molecular weight, density, viscosity, chemical functionality, and any combinations thereof Separation units may be located on the reactor vehicle, or may be at a fixed location that is not on-board the reactor vehicle.

When the alcohol is (or includes) methanol, a glycerin product is co-produced from the transesterification. The glycerin may be separated and stored, sold, or used for various purposes. For example, the glycerin may be reformed to syngas (which may be used for power), or directly oxidized to generate power. In some embodiments, the glycerin, alone or in combination with biodiesel fuel, may be reformed or oxidized to generate combined heat and power. The power, or combined heat and power, may be utilized by the reactor vehicle, if desired, such as for air conditioning and on-board electronics.

The biodiesel fuel produced may be introduced, directly or via a fuel blend, into one or more fleet vehicles located at, or otherwise associated with, the customer site. A customer site may consist of a refiner (manufacturer) of cooking oil, a supplier of cooking oil, a user of cooking oil, or a distribution center associated with a plurality of suppliers and/or users of cooking oil.

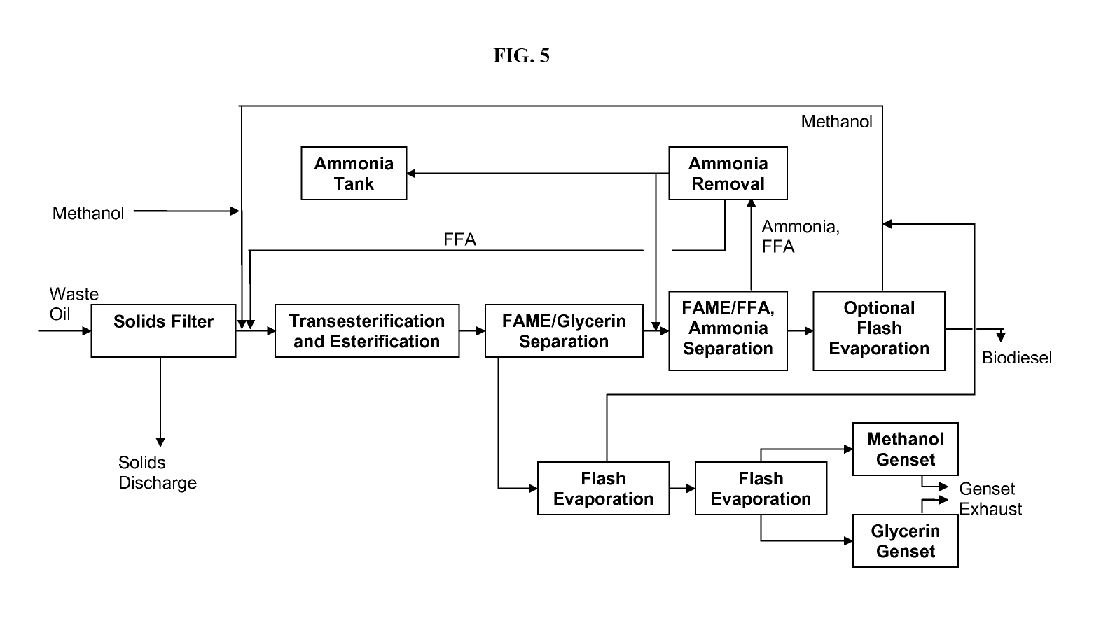

FIG. 5 is an exemplary block-flow diagram depicting various steps and options associated with the mobile reactor and ancillary equipment. The variation illustrated in FIG. 5 for producing biodiesel fuel from waste vegetable oil includes combined transesterification and esterification in a CSTR enzyme reactor, methanol to power, glycerin to power, and no liquid discharge, among other features and options.

Variations of the present invention relate to systems and apparatus, including systems and apparatus configured for carrying out any of the disclosed methods.

In some variations, the invention provides a system for providing a service to cooking oil users, distributers, or other market participants, the system comprising a computer server configured to exchange data with the Internet, the server computer having a processor, an area of main memory for executing program code under the direction of the processor, a storage device for storing data and program code and a bus connecting the processor, main memory, and the storage device; the code being stored in the storage device and executing in the main memory under the direction of the processor, to perform the steps of:

(a) identifying a network comprising a plurality of customer distribution centers, wherein each of the customer distribution centers is associated with a plurality of users of cooking oil;

(b) at a first customer distribution center, collecting used cooking oil transported from at least some of the users associated with the first customer distribution center, and introducing the used cooking oil to a first storage unit;

(c) providing a mobile reactor configured to convert used cooking oil into biodiesel fuel under effective reaction conditions;

(d) transporting the mobile reactor to the first customer distribution center;

(e) feeding at least some of the used cooking oil contained in the first storage unit to the mobile reactor;

(f) co-feeding methanol and a catalyst to the mobile reactor, under effective reaction conditions, to produce biodiesel fuel on-site at the first customer distribution center; and

(g) introducing at least some of the biodiesel fuel, directly or via a fuel blend, into one or more fleet vehicles associated with the first customer distribution center.

In some embodiments, the code under the direction of the processor is programmed to perform the additional steps of:

(h) at additional customer distribution centers, collecting used cooking oil transported from at least some of the users associated with each of the additional customer distribution centers, and introducing the used cooking oil to individual storage units located at each of the additional customer distribution centers;

(i) transporting the mobile reactor to each of the additional customer distribution centers;

(j) at each of the additional customer distribution centers, feeding at least some of the used cooking oil contained in each of the individual storage units to the mobile reactor; and

(k) at each of the additional customer distribution centers, feeding methanol and a catalyst to the mobile reactor, under effective reaction conditions and in the presence of the used cooking oil, to produce biodiesel fuel on-site at each of the additional customer distribution centers.

A system for providing a service to cooking oil users, distributers, or other market participants, is also provided herein, comprising:

(a) a computer server connected to the Internet;

(b) executable program code configured to create or maintain a database of customer distribution centers, wherein each of the customer distribution centers is associated with a plurality of users of cooking oil, and wherein the database is connected to the computer server;

(c) a user interface programmed to allow selection of a first customer distribution center from the database;

(d) a first storage unit, at the first customer distribution center, for collecting used cooking oil transported from at least some of the users associated with the first customer distribution center;

(e) a mobile reactor configured to convert used cooking oil into biodiesel fuel under effective transesterification conditions at the first customer distribution center;

(f) a first pump or other means for feeding at least some of the used cooking oil contained in the first storage unit to the mobile reactor;

(g) a second pump or other means for feeding methanol and a catalyst to the mobile reactor, under effective reaction conditions and in the presence of the used cooking oil, to produce biodiesel fuel on-site at the first customer distribution center; and

(h) a third pump or other means for introducing at least some of the biodiesel fuel, directly or via a fuel blend, into one or more fleet vehicles associated with the first customer distribution center.

The user interface may be programmed to allow selection of additional customer distribution centers included in the database; the system further comprising:

(i) individual storage units located at each of the additional customer distribution centers;

(j) first additional pumps or other means for feeding at least some of the used cooking oil contained in the individual storage units to the mobile reactor;

(k) second additional pumps or other means for feeding methanol and a catalyst to the mobile reactor, under effective reaction conditions and in the presence of the used cooking oil, to produce biodiesel fuel on-site at each of the additional customer distribution centers; and

(l) third additional pumps or other means for introducing at least some of the biodiesel fuel, directly or via a fuel blend, into one or more fleet vehicles associated with each of the additional customer distribution centers.

In some embodiments, the system further includes an optimization routine for route planning or for dynamic route adjustments. In some embodiments, the mobile reactor can be operated, at least in part, remotely via connection between the computer server and an on-board computer attached to the mobile reactor.

In certain embodiments, the system further includes program code for managing the generation and/or disposition of renewable identification numbers or other credits associated with the biodiesel fuel.

The system of the invention may be adapted for a mobile-computing application on any known platform and media, if desired. This invention may be implemented on any current or future computer device. Current examples include, but are not limited to, a Mac or PC laptop, Android, BlackBerry, iPhone, iPad, Treo, Palm, or Windows Phone.

Other variations of this invention relate to compositions. The invention provides a biodiesel fuel composition produced by a process as disclosed. A diesel fuel may be produced, including this biodiesel fuel composition, and used in any known diesel fuel application. Preferred compositions are capable of burning in an internal combustion engine. Preferred compositions are suitable as a diesel fuel, or as an additive to a diesel fuel.

In some embodiments, the biodiesel composition meets the specification set forth in ASTM D975 and/or ASTM D396-08c. In some embodiments, the composition further comprises a diesel fuel in a suitable blend, wherein the blend meets the specification set forth in ASTM D7467-08.

All publications, patents, and patent applications cited in this specification are incorporated herein by reference in their entirety as if each publication, patent, or patent application was specifically and individually put forth herein. All ASTM specifications recited herein are also incorporated by reference. Additionally, all relevant U.S. laws, rules, procedures, tax code, and the like, with respect to biodiesel fuel production, distribution, and use, are incorporated by reference herein.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

1. A method of providing a service to cooking oil users, distributers, or other market participants, said method comprising:
(a) identifying a network comprising a plurality of customer distribution centers, wherein each of said customer distribution centers is associated with a plurality of users of cooking oil;
(b) at a first customer distribution center, collecting used cooking oil transported from at least some of the users associated with said first customer distribution center, and introducing said used cooking oil to a first storage unit;
(c) providing a mobile reactor configured to convert used cooking oil into biodiesel fuel under effective reaction conditions;
(d) transporting said mobile reactor to said first customer distribution center;
(e) feeding at least some of said used cooking oil contained in said first storage unit to said mobile reactor;
(f) feeding an alcohol and a catalyst to said mobile reactor, under said effective reaction conditions and in the presence of said used cooking oil, to produce biodiesel fuel on-site at said first customer distribution center; and
(g) introducing at least some of said biodiesel fuel, directly or via a fuel blend, into one or more fleet vehicles associated with said first customer distribution center.

2. The method of claim 1, said method further comprising:
(h) at additional customer distribution centers, collecting used cooking oil transported from at least some of the users associated with each of said additional customer distribution centers, and introducing said used cooking oil to individual storage units located at each of said additional customer distribution centers;
(i) transporting said mobile reactor to each of said additional customer distribution centers;
(j) at each of said additional customer distribution centers, feeding at least some of said used cooking oil contained in each of said individual storage units to said mobile reactor; and
(k) at each of said additional customer distribution centers, feeding methanol and a catalyst to said mobile reactor, under said effective reaction conditions and in the presence of said used cooking oil, to produce biodiesel fuel on-site at each of said additional customer distribution centers.

3. The method of claim 2, said method further comprising, at each of said additional customer distribution centers, introducing at least some of said biodiesel fuel produced in step (k), directly or via a fuel blend, into one or more fleet vehicles associated with said additional customer distribution centers.

4. The method of claim 1, wherein a vehicle is provided to transport fresh cooking oil to each of said plurality of users of cooking oil, and wherein said vehicle is further employed to transport said used cooking oil to said first customer distribution center.

5. The method of claim 1, wherein said network includes at least 10 customer distribution centers.

6. (canceled)

7. The method of claim 1, wherein substantially all of said biodiesel fuel is introduced, directly or via a fuel blend, into one or more fleet vehicles associated with said first customer distribution center.

8. The method of claim 1, wherein at least some of said biodiesel fuel is utilized to power a vehicle to transport fresh cooking oil to a user of cooking oil.

9. The method of claim 1, wherein at least some of said biodiesel fuel is utilized to power a vehicle to transport said used cooking oil to said first customer distribution center.

10. The method of claim 1, wherein a portion of said biodiesel fuel is separately marketed or sold.

11. The method of claim 1, said method further comprising transporting said mobile reactor directly to at least one of said plurality of users of cooking oil.

12. The method of claim 1, wherein multiple mobile reactors are provided, each configured to convert used cooking oil into biodiesel fuel under effective reaction conditions.

13. The method of claim 1, wherein at least some of said biodiesel fuel is utilized to power a supplier vehicle to deliver fresh cooking oil to said first customer distribution center, and/or for a return trip for said supplier vehicle back to a supplier location.

14. The method of claim 1, said method further comprising transporting said mobile reactor to a supplier of fresh cooking oil, to convert waste oil or off-spec cooking oil into biodiesel fuel.

15. The method of claim 1, said method further comprising transporting said mobile reactor to a refiner of fresh cooking oil, to convert waste oil or off-spec cooking oil into biodiesel fuel.

16. The method of claim 1, wherein used cooking oil generated by a user associated with said first customer distribution center is evacuated from a cooker into a portable container, followed by pumping said used cooking oil to interior tank storage at a storage site of said user.

17. The method of claim 1, wherein used cooking oil generated by a user associated with said first customer distribution center is directly evacuated from a cooker into interior tank storage at a storage site of said user.

18. The method of claim 1, wherein used cooking oil generated by a user associated with said first customer distribution center is evacuated from a cooker into a portable container, followed by pumping said used cooking oil to exterior tank storage at a storage site of said user.

19. The method of claim 1, wherein used cooking oil generated by a user associated with said first customer distribution center is directly evacuated from a cooker into exterior tank storage at a storage site of said user.

20-22. (canceled)

23. The method of claim 1, wherein used cooking oil generated by a user associated with said first customer distribution center is introduced into a portable, reusable container which is transported to said first customer distribution center.

24-25. (canceled)

26. The method of claim 1, wherein step (g) comprises pumping said biodiesel fuel into an on-site biodiesel storage tank, followed by introducing or blending said biodiesel fuel into a customer fueling system configured to provide fuel for said fleet vehicles associated with said first customer distribution center.

27-35. (canceled)

36. A method of converting used cooking oil into biodiesel fuel, said method comprising:
(a) introducing, or causing to be introduced, used cooking oil into a used oil storage unit at a customer site;
(b) transporting a mobile reactor to said customer site using a reactor vehicle, wherein said mobile reactor is configured to continuously convert used cooking oil into biodiesel fuel under effective reaction conditions;
(c) feeding at least some of said used cooking oil contained in said used oil storage unit to said mobile reactor; and
(d) feeding an alcohol and a transesterification catalyst to said mobile reactor, under said effective reaction conditions and in the presence of said used cooking oil, to continuously or semi-continuously produce biodiesel fuel on-site at said customer site.

37. The method of claim 36, wherein said mobile reactor is capable of processing at least about 500 gallons of said used cooking oil per hour.

38. (canceled)

39. The method of claim 36, wherein step (d) is operated continuously.

40. The method of claim 36, wherein said cooking oil is derived from a food source selected from the group consisting of soybeans, corn, canola, rice, olive, coconut, cottonseed, palm, peanut, rapeseed, safflower, sesame, sunflower, pumpkin, grape, animal fat, energy crops, and combinations thereof.

41. The method of claim 36, wherein said alcohol comprises methanol.

42. The method of claim 36, wherein said alcohol comprises a C₂-C₆ alcohol.

43. The method of claim 42, wherein said alcohol comprises a mixture of methanol and ethanol.

44. The method of claim 36, wherein said transesterification catalyst is a strong alkali catalyst.

45. The method of claim 36, wherein said transesterification catalyst is an enzymatic transesterification catalyst.

46. The method of claim 36, said method further comprising feeding an esterification catalyst to said mobile reactor.

47. The method of claim 46, wherein said esterification catalyst is an enzymatic esterification catalyst.

48. The method of claim 36, wherein said alcohol and said transesterification catalyst are co-fed to said mobile reactor.

49. The method of claim 36, wherein substantially no wastewater is directly discharged in connection with production of said biodiesel fuel.

50. The method of claim 36, wherein said mobile reactor is energy self-sufficient and requires substantially no on-site utilities.

51. The method of claim 36, wherein said alcohol is methanol and whereby glycerin is produced from said transesterification; said method further comprising reforming or directly oxidizing said glycerin to generate power.

52. The method of claim 51, said method comprising reforming or directly oxidizing said glycerin to generate combined heat and power.

53-55. (canceled)

56. The method of claim 36, wherein said customer site is a refiner of cooking oil.

57. The method of claim 36, wherein said customer site is a supplier of cooking oil.

58. The method of claim 36, wherein said customer site is a user of cooking oil.

59. The method of claim 36, wherein said customer site is a distribution center associated with a plurality of users of cooking oil.

60-71. (canceled)
